(19) United States
(12) Patent Application Publication
(10) Pub. No.: US 2025/0270432 A1
(43) Pub. Date: Aug. 28, 2025

(54) INTEGRATED SYSTEM AND PROCESS FOR PRODUCING RECLAIMED, STABILIZED AND TRACEABLE REFRIGERANT COMPOSITIONS

(71) Applicant: THE CHEMOURS COMPANY FC, LLC, WILMINGTON, DE (US)

(72) Inventors: SHENG PENG, HOCKESSIN, DE (US); BARBARA HAVILAND MINOR, THE VILLAGES, FL (US); JIAN SUN-BLANKS, ARAB, AL (US); ANDREW R. PANSULLA, WEST CHESTER, PA (US); ANTHONY F. STASIO, NEWARK, DE (US); JOSHUA HUGHES, WILMINGTON, DE (US); DAVID MATTHEW SNYDER, DREXEL HILL, PA (US)

(73) Assignee: THE CHEMOURS COMPANY FC, LLC, WILMINGTON, DE (US)

(21) Appl. No.: 18/867,311

(22) PCT Filed: May 22, 2023
(86) PCT No.: PCT/US2023/023075

§ 371 Date: Nov. 19, 2024

Related U.S. Application Data
(60) Provisional application No. 63/344,876, filed on May 23, 2022.
(60) Provisional application No. 63/422,656, filed on Nov. 4, 2022.

(51) Int. Cl. C09K 5/04

(52) U.S. Cl. CPC C09K 5/045; C09K 2205/122

(57) ABSTRACT

The present invention relates to an integrated system and process for reclaiming fluoroolefin refrigerant compositions which are unsuitable for and non-compliant with existing industry and environmental standards and producing industry compliant refrigerant compositions that are traceable and stabilized to prevent fluoroolefin components from oligomerization or polymerization.

### FIELD OF THE INVENTION

The present invention relates to an integrated system and process for reclaiming refrigerant materials containing impurities and contaminants which render them unsuitable for and non-compliant with existing industry and environmental standards and producing industry compliant refrigerants and refrigerant blends that are traceable and/or stabilized against oligomerization/polymerization.

### BACKGROUND OF THE INVENTION

Over the past decade, the refrigeration industry has been replacing ozone depleting chlorofluorocarbons (CFCs) and Hydrochlorofluorocarbons (HCFCs) with low zero ozone depletion hydrofluorocarbons (HFCs). More recently, fluoroolefins such as HFO-1234yf (2,3,3,3-tetrafluoropropene), HFO-1234ze (1,3,3,3-terafluoropropene, the Z-isomer, the E-isomer or blends of the E and Z isomer), HFO-1234yf and HFO-Z/E-1234ze, alone or blended with HFCs (hydrofluorocarbons) are being used, many of which are commercially available such as the Chemours Opteon™ line of refrigerants and Honeywell Solstice® line of refrigerants, including R-448A. However, the olefinic portion of the hydrofluoroolefin molecule may exhibit reactivity toward materials encountered during use. Typically, HFO reactivity is encountered during extreme use conditions (i.e., conditions outside the normal operating conditions of the refrigerant and/or refrigerant blend), or misuse such as blending with incompatible products or introducing counterfeit materials or inadvertent contamination. Therefore, the resultant reactivity of the HFO portion of the refrigerant or refrigerant blend may degrade in such a way as to result in unwanted by-products. The resulting formation of by-products introduce materials into the refrigerant composition which can degrade the desired or intended performance of the refrigerant, as well as any lubricant that may be present. One source of impurities may be the result of side reactions acting on one or more of the refrigerants in the system. The side reactions may result from various processes including, for example, thermal degradation, polymerization, oxidation, or hydration. The side reactions may occur between materials in the system or as a result of external materials gaining entry to the system, such as air or water. The resulting impurities may include, for example, alcohols, aldehydes, ketones, oligomers, or polymers resulting from the reaction of one or more refrigerants. Another source of impurities may result from side reactions acting on other materials present in the system, such as lubricant oils. These may include, for example, polyolesters, polyvinyl ethers, polyaklylene glycols, mineral oils or alkyl benzene oils. In one embodiment, polyolester lubricants may hydrolyze to the corresponding acid. The resulting impurities may be present as solids, liquids, or gases. Additionally, materials such as thread locking agents can also initiate unwanted by-products. Other sources of unwanted contaminants include plasticizers from hoses, gaskets and O-rings. Since the refrigerants now have unknown impurities in them that cannot be conveniently removed during a recovery or recycle processes using technique that were suitable for chlorofluorocarbons (CFCs), hydrochlorofluorocarbons (HCFCs) and hydrofluorocarbons (HFCs) reclamation, these degraded HFO containing refrigerants are discarded (destroyed), and the system is recharged with fresh, i.e., new or virgin refrigerants or refrigerant blends. This leads to unnecessary loss of high value refrigerant or refrigerant blends.

Thus, there is a need for systems and methods to recycle and reclaim degraded fluoroolefin refrigerant compositions for further use in the existing system or re-use in a new system. It may also be desirable to improve the degraded fluoroolefin refrigerant or refrigerant blends, remove the contaminants and re-blend the neat or existing blend with other materials to form a new blend or even an improved performance blend.

### SUMMARY OF THE INVENTION

The present invention can solve problems associated with the unique properties and by-product contaminants not encountered with the conventional reclamation of CFCs and HCFCs by providing systems and methods for recovering, testing, treating, controlling and reformulating refrigerant compositions for reuse/recycling unreclaimed fluoroolefin containing refrigerant compositions, wherein the systems and methods are preferably integrated and include, but are not limited to fluoroolefins comprising HFO-1234yf, HFO-Z/E-1234ze, HFO-E-1225ye, HFO-1132a, HFO-Z/E-1132 and HFO-Z/E-1336mzz alone, or combined with one or more of additional members selected from HFC-152a, HFC-134a, HFC-134, HFC-32, HFC-125, HFC-143a, HFC-227ea, CO₂(R744), HFO-1123 (1,1,2-trifluoroethylene), HFO-1224yf, HFO-Z/E-1233zd, HFO-Z/E-1336mzz, HCO-1130 (E), HFO-1132, HFO-1132a, and CF₃I.

The present invention also relates to an integrated system and process for treating unreclaimed refrigerant compounds, components and blends which are analyzed, purified, adjusted, and reconstituted or reformulated to possess purity properties consisting with AHRI-700 refrigerant standards, and then rendered traceable and/or stabilized against oligomerization or polymerization.

The present invention relates to reclaiming procedures that provide HFC/HFO/HCFO refrigerant compositions that not only meet AHRI 700 (2019) standards and have the same stability as virgin packaged HFCs, HFOs and HCFOs (and mixtures containing HFCs/HFOs/HCFOs), but also are stabilized to guard against oligomerization or polymerization of fluoroolefin components, such as HFO-1234yf, and traceable to identify the source of the reclaimed HFCs, HFOs and HCFOs (and mixtures containing HFCs/HFOs/HCFOs).

The present invention produces traceable and reclaimed refrigerant compositions with improved ability to withstand conventional and abnormal conditions, and also solves potential problems associated with initiators (e.g., contaminants) causing a fluoroolefin (e.g., tetrafluoropropene) to oligomerize or homopolymerize, because at least one inhibitor has been added to the fluoroolefin containing composition. Adding the oligomer inhibitor to the reclaimed fluoroolefin containing compositions will increase the stability thereof during packaging, storage and usage in refrigeration or air-conditioning system applications. The stabilized compositions may be useful in cooling systems and as replacements for existing refrigerants with higher global warming potential.

Embodiments of the present invention disclosed herein include, for example, a system for recovering used, spent, e.g., unreclaimed refrigerant from refrigerant equipment and storage vessels, including a testing station to determine physical and chemical properties of the refrigerant compositions to be reclaimed. The testing station will necessarily include a used, spent, e.g., unreclaimed refrigerant receiving vessel which can facilitate the determination of the physical and chemical properties of the refrigerant compositions to be reclaimed prior to purification, including but not limited to the weight of the refrigerant compositions, NAG (non-absorbable gas) content, acidity, air, oil, particulates/solids, stabilizer, moisture, HFO, HFC, HCFO, other refrigerant content, and purity for comparison to industry standards. The receiving vessel can be ASHRAE and AHRI compliant thereby providing an overhead/vapor space for the collection of vapor, and non-absorbable or non-condensable gases. Sensors or detectors can be associated directly with the overhead/vapor space for measuring the air, oxygen or moisture content of the unreclaimed refrigerant, or inline via a sampling valve.

Upon determining the chemical and/or physical properties of the unreclaimed refrigerant in the testing station, the unreclaimed refrigerant is passed to a primary or first purification station where the unclaimed refrigerant is treated in at least one of a distillation station, an adsorption station, a desorption station and a cryogenic cooling station, and is then analyzed again to determine the purity of the treated refrigerant, and its purity and industry compliance. If appropriate, the once treated refrigerant composition or blends are transferred to a second purification station for targeted purification of at least one of purification, including, but not limited to, NAG (purge stations), water (distillation/desiccant dryer), solids (filters), acidity (base bath), high boiling residue/chloride (distillation), and retested to verify purity and industry compliance. Once reclaimed, the reclaimed refrigerant components or blends are transferred to or collected in an ASHRAE or AHRI compliant reclaimed refrigerant collection container/vessel which can be part of an adjustment Station to add additional refrigerant components to make the targeted refrigerant or refrigerant blend. Thereafter, the targeted compliant refrigerant or refrigerant blend is stabilized and made traceable, and its purity checked to make sure the reclaimed refrigerant meets or exceeds AHRI 700 standards. Like the unreclaimed refrigerant receiving vessel, the reclaimed refrigerant collection container/vessel provides an overhead/vapor space for the collection of vapor, and non-absorbable or non-condensable gases. Sensors or detectors can be associated directly with the overhead/vapor space for measuring the air, oxygen or moisture content.

In one particular embodiment, the invention relates to processing unreclaimed fluoroolefin containing compositions comprising HFO-1234yf and/or HFO-Z/E-1234ze to produce high purity and AHRI compliant HFO-1234yf and/or HFO-Z/E-1234ze blends.

In another particular embodiment, the invention relates to processing unreclaimed refrigerant mixtures which comprise at least 2,3,3,3-tetrafluoropropene (HFO-1234yf) and at least one additional member comprising a C₂ hydrofluorocarbon, including but not limited to,
HFC-32, HFC-125, HFC-134, HFC-134a, HFC-143a, or HFC-152a, and optionally carbon dioxide; or
HFC-32 and HFC-125; or
HFC-32 and HFC-134a; or
HFC-32 and HFC-152a; or
R-448A, R449A, R-454A, R-454B, R454C, R-463A, R-513A, R-516A, or R-457A.

In another particular embodiment, the invention relates to processing unreclaimed refrigerants and mixtures which comprise 2,3,3,3-tetrafluoropropene (HFO-1234ze (E)) alone or containing at least one C₂ or C₃ hydrofluorocarbon selected from HFC-227ea, HFC-134a, HFC-134, HFO-1336mzz (E), HFO-1225ye (E), HCFO-1224 yd (Z), HCFO-1224 yd (E), HFO-1234ze (Z), HCFO-1233zd (E).

In another particular embodiment, the invention relates to processing unreclaimed 2,3,3,3-tetrafluoropropene (HFO-1234ze (E/Z)) refrigerants blends, including but not limited to, R471A, R476A, R482A, R515A, and R-515B.

In another particular embodiment disclosed herein, unreclaimed refrigerant and refrigerant blend components include, but are not limited to HFO-1234yf, HFO-Z/E-1234ze, HFO-Z/E-1336mzz, HFC-152a, HFC-134a, HFC-32, HFC-125, HFC-143a, HFC-227ea, HFO-1123, HFO-E-1225ye, HFO-1132a, or HFO-E/Z-1132, and are separated and purified into individual component suitable for re-blending.

In other particular embodiments disclosed herein, unreclaimed refrigerants and refrigerant blends to be treated can include, but are not limited to,
R404A, (ASHRAE designation for a blend of 44 weight percent R125, 52 weight percent R143a (1,1,1-trifluoroethane), and 4.0 weight percent R134a); or
R407A, R407B, R407C, R407D, and R407E (ASHRAE designations for blends of R134a, R125 (pentafluoroethane), and R32 (difluoromethane) in differing component concentrations); or
R408A (ASHRAE designation for a blend of 7 weight percent R125, 46 weight percent R143a, and 47 weight percent R22); or
R410A (ASHRAE designation for a blend of 50 weight percent R125 and 50 weight percent R32); or
R413A (ASHRAE designation for a blend containing R218, R134a, and isobutane); R417A, (ASHRAE designation for a blend of 46.6 weight percent R125, 50.0 weight percent R134a, and 3.4 weight percent n-butane); or
R419A (ASHRAE designation for a blend containing R125, R134a and DME); or
R422A, R422B, R422C and R422D, (ASHRAE designation for blends of R125, R134a, isobutane in differing component concentrations), or
R423A (ASHRAE designation for a blend containing R134a and 1,1,1,2,3,3,3-heptafluoropropane (R227ea)); R424A (ASHRAE designation for a blend containing R125, R134a, isobutane, n-butane, and isopentane); R426A (ASHRAE designation for a blend containing R125, R134a, n-butane, and isopentane); or
R427A (ASHRAE designation for a blend of 15 weight percent R32, 25 weight percent R125, 50 weight percent R134a, and 10 weight percent R143a); or
R428A (ASHRAE designation for a blend containing R125, R143a, propane and isobutane); or
R430A (ASHRAE designation for a blend containing R152a and isobutane); or
R434A (ASHRAE designation for a blend containing R125, R134a, R143a, and isobutane); or
R437A (ASHRAE designation for a blend containing R125, R134a, n-butane, and n-pentane); or
R438A (ASHRAE designation for a blend containing R32, R125, R134a, n-butane, and isopentane); or
R507A and R507B (ASHRAE designation for a blend of R125 and R143a in differing component concentrations); or
R508A and R508B (ASHRAE designations for blends of trifluoromethane (R23) and hexafluoroethane (R116) in differing component concentrations); or
R471A (ASHRAE designations for blends of R-1234ze (E), R-227ea and HFO-1336mzz (E) (78.7/4.3/17.0 weight percent)); or
R473A (ASHRAE designations for blends of R-1132a/R-23/R-744/R-125 (20.0/10.0/60.0/10.0); or
R474A (ASHRAE designations for blends of R-1132 (E) and R-1234yf (23.0/77.0 weight percent)); or
R-514A (ASHRAE designations for blends of R-1336mzz (Z) and R-1130 (E) (74.7/25.3 weight percent); or
R-515A (ASHRAE designations for blends of R-1234ze (E) and R-227ea (88.0/12.0 weight percent)); or
R-515B (ASHRAE designations for blends of R-1234ze (E) and R-227ea (91.1/8.9 weight percent)); or
R-516A (ASHRAE designations for blends of R-1234y, R-134a and R-152a (77.5/8.5/14.0 weight percent)); or
R-457A (ASHRAE designation for blends of R-32, R-1234yf and R-152a (18.0/70.0/12.0 weight percent)); or
R-463A (ASHRAE designation for blends of R-744/32/125/1234yf/134a (6.0/36.0/30.0/14.0/14.0)).

In another embodiment the system, preferably integrated, includes a blending station to reconstitute or reformulate blends to be compliant with AHRI-700 standards including, but not limited to,
(1) HFC-32, HFC-125, HFO-1234yf and HFC-R134a; or
(2) HFC-32 and HFO-1234yf;
(3) HFC-32, HFC-134a and HFC-152a; or
(3) HFO-1234yf, HFC-32, HFC-125, HFC-134a and HFO-Z/E-1234ze; or
(4) HFO-1234yf, HFC-32, HFC-125 HFC-134a having up to about 10 weight percent trans-HFO-1234ze; or
(5) HFO-1234ze(E) and HFO-1336mzz(E).

In other embodiments, the system can be an integrated system which tests, reclaims, and produces high purity refrigerant components including, but not limited to, at least one of HFO-1234yf, HFO-Z/E-1234ze, HFO-E/Z-1336mzz, HFO-1225ye, HFO-1132a, HFC-1130 (E), HFO-1123, E/Z-HFO-1132, HFC-134a, HFC-32, HFC-125; HFC-227ea; HFC-236fa or HFC-134.

In one embodiment of the invention, unreclaimed R-407C which is a blend of HFC-32, HFC-125, HFC-134a, is tested, purified, and separated into HFC-32, HFC-125 and HFC-134a components and re-blended and compositionally adjusted to be compliant with AHRI-700 standards for reuse and modified to include an effective amount of an oligomer/polymer inhibiting agent and/or a tracer.

The reclaimed refrigerant compositions disclosed herein may also include an effective amount of an oligomer/polymer inhibiting agent including, but not limited to, hydrocarbons comprising at least one of cyclic monoterpene; lipophilic organic compounds including tocopherols such as a-Tocopherol; phenols, aromatic organic compounds having at least one chemical moiety C₆H₄(OH) including benzene-1,4-diol, specifically at least one member selected from the group consisting of limomene, α-terpinene, a-tocopherol, butylated hydroxytoluene, 4-methoxyphenol, benzene-1,4-diol, used in effective amount up to 0.5% by weight of the HFO and HFC refrigerants. Examples of such an inhibitor comprise at least one of limonene and α-terpinene. Limonene has the following structure:

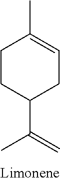

In one embodiment of the invention, limonene or α-terpinene optionally with an antioxidant has unique a fragrance even at a few ppm level. This pleasant odor can be utilized for refrigerant leakage detection with refrigerants and blends based on hydrofluoroolefins (e.g., comprising at least one of 1234yf, 1234ze and combinations thereof). This is especially beneficial for early refrigerant leakage detection in household air conditioner or mobile air conditioner as paraprofessional electronic leak detectors often are not available in either location.

The reclaimed refrigerant compositions disclosed herein also include an effective amount of an oligomer/polymer inhibiting agent including, but not limited to, ethane, propane, propylene, butane, butene, isobutene, and xylene used alone or with limonene or terpinene in effective amount up to 0.5% by weight of the HFO and HFC refrigerants. Disclosed herein are reclaimed fluoroolefin compositions including any of the foregoing inhibitors in amounts up to and including about 0.5 wt. %, less than 0.5 w/t % but greater than 0, e.g., 0.001 wt. %, 0.005 wt. %, 0.01 wt. %, 0.015 wt. %, 0.02 wt. % 0.03 wt. %, 0.04 wt. %, 0.05 wt. % (500 ppm), 0.06 wt. %, 0.07 wt. %, 0.08 wt. %, 0.09 wt. %, 0.1 wt. % (1000 ppm), 0.2 wt. %, 0.3 wt. % (3000 ppm) 0.4 wt. % 0.5, and all values therebetween, but present in amount sufficient to keep the formation of oligomer, homopolymer or other polymeric products less than about 0.03 wt. %, or provide a composition free of oligomer, homopolymer or other polymer products.

Reclaimed refrigerant compositions disclosed herein comprise at least one tracer member selected from HFO-E-1336mzz, HFO-1123, HCFO-1233zd, 1224 yd, CFO-1112, HFO-1327, HFO-Z-1336mzz, HFO-1336yf, HFO-1336ze and HFC-263fb, in amounts up to about 5000 ppm.

Another embodiment of the invention relates to an integrated system where unreclaimed compositions disclosed herein include one or more analyses and one or more treatments including, but not limited to, recovery and transfer, contaminant detection, physical and chemical property determination, purity checks, distillation, adsorption, desorption, cooling, solid and liquid separation, filtration, drying, neutralization, blending, addition of stabilizers, tracers, compatibilizers, and packaging, recycling and charging of refrigerant equipment with reclaimed compositions disclosed herein.

Another embodiment of the invention relates to an integrated system for processing unreclaimed HFO-1234yf and HFO-1234yf blend compositions, containing inhibitors and/or their oxidized derivatives, involving one or more analyses and one or more treatments including, but not limited to, recovery and transfer, contaminant detection, physical and chemical property determination, purity checks, distillation, adsorption, desorption, cooling, solid and liquid separation, filtration, drying, and neutralization.

In one treatment embodiment, an unreclaimed liquid refrigerant is passed through an absorbent material, such as silica gel, or the refrigerant is passed through mineral oil, molecular sieves, carbon, activated carbon, alumina, or diatomaceous earth, all prior to distillation to provide an inhibitor free partially reclaimed product which is then subjected to one or more distillations, in at least one of the first and/or second purification treatments, or as a vapor through mineral oil prior to distillation.

In another treatment embodiment, an unreclaimed liquid refrigerant is passed through one or more distillation columns and then through an absorbent material, such as silica gel, or the refrigerant is passed through mineral oil, molecular sieves, carbon, activated carbon, alumina, or diatomaceous earth to provide an inhibitor-free, at least partially reclaimed product.

Another embodiment of the disclosed invention relates to a system or process including multiple assessments including purity checks relative to at least current AHRI 700 standards.

Another embodiment of the disclosed invention relates to multiple purifications including, but not limited to, distillation selected from one or more of adsorption, desorption and cryogenic cooling, moisture removal selected from one of distillation, drying and desiccation, and neutralization of acidic components.

Another embodiment of the invention relates to any combination of the embodiments disclosed herein which result in reclaimed refrigerants having a purity which is greater than 99.5 weight percent, or greater than 99.9 weight percent, based on the total weight of the refrigerant composition.

### BRIEF DESCRIPTION OF THE DRAWINGS

FIG. 1 is a block diagram of a method and system for reclaiming unreclaimed refrigerant according to an embodiment of the invention.

### DETAILED DESCRIPTION OF THE INVENTION

The present invention preferably relates to integrated systems and processes for treating unreclaimed refrigerant compounds, components and blends which are analyzed, purified, adjusted and reconstituted to comply with AHRI 700 refrigerant standards, and then stabilized and/or rendered traceable.

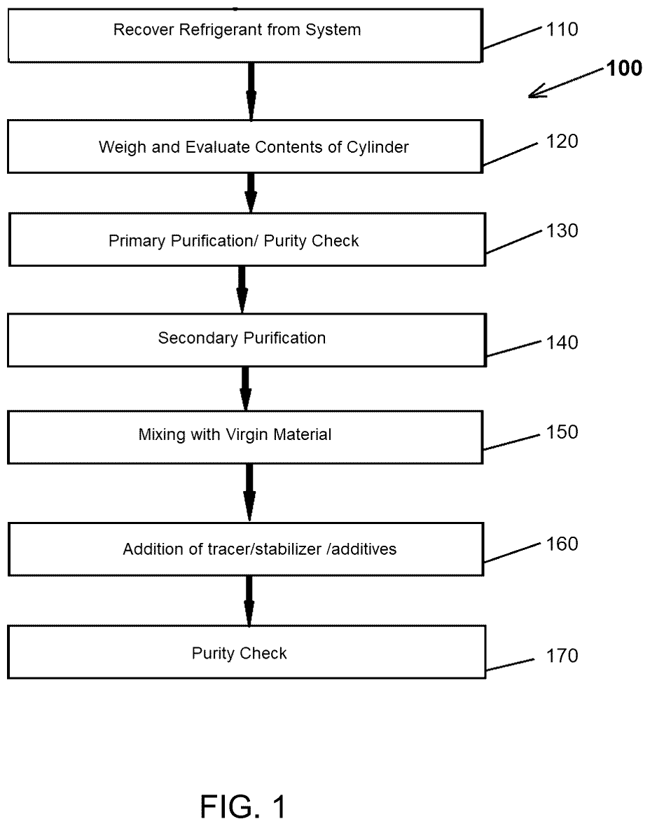

Referring to FIG. 1, the block diagram 100 illustrates a non-limiting example of the process and system for reclaiming refrigerant. Unreclaimed refrigerant from refrigerant equipment or storage vessels is collected using system 110, e.g., from a source vessel (or equipment) and collected in a receiving vessel, and the receiving vessel is transported to a recycling center. The refrigerant collected by the receiving vessel from 110 (not shown) is weighed and analyzed in-part by including an oxygen/air sensor in the vapor space of the receiving vessel of the system 110, or in contact with the vapor space of the unreclaimed refrigerant associated with the receiving vessel or a vessel housing the unreclaimed refrigerant (not shown) in the weighing and testing station or system 120 to detect and measure impurities, including but not limited to NAG (non-absorbable gases), acids, solids, water and/or high boiling residue content. As system 100 is designed to remove solids using filters, optionally the filter should be capable of removing oligomeric, homopolymeric and/or polymeric by-products from unreclaimed refrigerants containing fluoroolefins, such as HFO-1234yf. An oxygen sensor associated with the overhead/vapor space of the receiving vessel (not shown) or the unreclaimed refrigerant measures the air or oxygen content of the unreclaimed refrigerant and can signal the need for venting or treatment to remove/reduce the oxygen content. The unreclaimed refrigerant is analyzed using analytical techniques such as GC-FID, GC-TCD, GC-MS, FTIR, Goetz Bub, Karl Fischer, Byk-Garner Color and various other analytical methods. Generally, organic product analysis involves gas-chromatography (GC-MS).

The concentration of non-condensable gases (NCG) or non-absorbable gases (NAG) may vary or be altered, resulting in a concentration of less than 1.5 volume percent at 25° C., per AHRI 700, preferably below 0.9 volume percent at 25° C. per AHRI 700. NAG typically comprises air, (which is typically comprised of 78% nitrogen, 21% oxygen, and about 1% argon), accumulated in the vapor phase of refrigerants where they can be directly detected by a sensor and where the solubility of air in the refrigerant liquid phase is extremely low. While reducing the total amount of NAG contained within said refrigerant may be important, it is typically more desirable to reduce the oxygen containing portion of the NAG preferentially over the nitrogen portion. The oxygen containing portion, under certain scenarios, may increase the propensity of the refrigerant to decompose or form unwanted polymeric materials. NCGs may be detected using one of infrared sensors, UV sensors, NIR sensors, ion mobility or plasma chromatographs, gas chromatography, refractometry, mass spectroscopy, high temperature thick film sensors, thin film field effect sensors, pellistor sensors, Taguchi sensors and quartz microbalance sensors as disclosed in U.S. Patent 2008/0069177 incorporated herein by reference in its entirety.

The unreclaimed refrigerant component composition, even if provided by a customer, is analyzed as described above to assess the physical and chemical properties of the unreclaimed refrigerant composition and perform a purity check to see how it compares to the industry standard of AHRI-700. Based on the analytical (testing) results from the weighing and testing station, i.e., system 120, a first or primary purification will take place using a distillation column (adsorption/desorption and cryogenic cooling and/or other separations techniques) in system 130 and the first stage purified refrigerant will be reanalyzed and the purity thereof will be rechecked. The first or primary purification system 130 will optionally include one or more columns with absorbent/adsorbent to remove oligomerization inhibitors in the unreclaimed refrigerant compositions disclosed herein. The column (not shown) may be upstream or downstream of the distillation component of system 130. When silica gel is used as the medium to remove the inhibitor, the unreclaimed refrigerant can be passed through the bed of silica gel as a liquid and the inhibitor-free ‘partially’ reclaimed product is transferred to one of more distillation columns to separate and isolate individual refrigerant components as the case may be. Thereafter, if the primary purification does not provide a treated product that is AHRI-700 compliant, it is transferred from system 130 to system 140 for further processing including targeted purification for NAG (purge stations), water (distillation/desiccant dryer), solids (filters), acidity (base bath), high boiling residue/chloride (distillation), and the product is reanalyzed in the weighing and testing station, and the purity is rechecked to verify purity and industry compliance in system 140. The NAG reduction station (not shown) may contact the partially reclaimed refrigerant composition with a reducing agent, such as a metal powder, which may react with oxygen or other oxidizable components of the unreclaimed refrigerant composition. In one embodiment, the reducing agent may include iron powder. Treatment by the NAG reduction station may result in the concentration of one or more components of the partially reclaimed refrigerant composition being reduced to less than one or more predetermined thresholds.

Thereafter, in system 150, a reclaimed refrigerant collection container/vessel (not shown) that can be ASHRAE/AHRI compliant receives the reclaimed refrigerant components from 130 or 140 and the reclaimed refrigerant components are mixed with additional fresh/virgin/high purity refrigerant components to provide a reconstituted reclaimed refrigerant composition compliant with AHRI 700-19 standards in system 150. The reclaimed collection vessel can be provided with detectors in the headspace/vapor to determine the air and/or oxygen content. Tracers, stabilizers and conventional additives are added in system 160, and then a final purity check is performed in system 170 so that reclaimed and reconstituted refrigerant is compliant with AHRI 700-19 standards. Each system 110, 120, 130, 140, 150, 160 and 170 includes components for receiving and transferring refrigerant composition between upstream and downstream systems, such as flowlines, valves, pumps, controls, etc. (not shown).

In one embodiment, the concentration of non-condensable materials may be altered, resulting in a concentration of less than 1.5 volume percent at 25° C., per AHRI 700, preferably below 0.9 volume percent at 25° C. per AHRI 700.

In another embodiment, a condenser is used in conjunction with a cooling medium that is sufficiently cold enough to condense the partially reclaimed refrigerant and let the NAGs pass through with minimal loss of refrigerant. A compressor can be used in conjunction with the condenser to increase the pressure and make it easier to condense the refrigerant at a higher temperature.

In another embodiment, NAGs are separated from the refrigerant using a membrane which is placed such that the NAGs can pass through the membrane and are removed while the refrigerant does not pass through the membrane.

As used herein, a refrigerant is a compound or mixture of compounds that function as a heat transfer fluid in a cycle wherein the fluid undergoes a phase change from a liquid to a gas and back.

As used herein, a refrigerant is a compound or mixture of compounds (blend) that function as a heat transfer fluid in a cycle wherein the fluid undergoes a phase change from a liquid to a gas and back.

As used herein many of the compounds, components or members of the compositions or tracers may exist as different configurational isomers or stereoisomers. The present invention is intended to include all single configurational isomers, single stereoisomers or any combination thereof. For instance, 1,3,3,3-tetrafluoropropene (HFC-1234ze) or HFO-1336mzz is meant to represent the E-isomer, Z-isomer, or any combination or mixture of both isomers in any ratio. Similarly HFO-E/Z or HFO-Z/E may be used interchangeably to represent the E-isomer, Z-isomer, or any combination or mixture of both isomers in any ratio.

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified. If in the claim such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” is used to define a composition, method that includes materials, steps, features, components, or elements, in addition to those literally disclosed provided that these additional included materials, steps, features, components, or elements do not materially affect the basic and novel characteristic(s) of the claimed invention, especially the mode of action to achieve the desired result of any of the processes of the present invention. The term ‘consisting essentially of’ occupies a middle ground between “comprising” and ‘consisting of.’

Where applicants have defined an invention or a portion thereof with an open-ended term such as “comprising,” it should be readily understood that (unless otherwise stated) the description should be interpreted to also include such an invention using the terms “consisting essentially of” or “consisting of.”

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

As used herein the term “about” in certain embodiments can be quantified to mean±1%, ±2%, ±3% and up to and including ±10% of the stated value, and all whole numbers and fractions therebetween.

The reclaimed refrigerant compositions disclosed herein may also include as a stabilizer an effective amount of an oligomer/polymer inhibiting agent including, but not limited, hydrocarbons comprising at least one of cyclic monoterpene; lipophilic organic compounds including tocopherols such as a-tocopherol; phenols, aromatic organic compounds having at least one chemical moiety C₆H₄(OH) including benzene-1,4-diol, specifically at least one member selected from the group comprising, consisting essential or consisting of limomene, α-terpinene, a-tocopherol, butylated hydroxytoluene, 4-methoxyphenol, benzene-1,4-diol, used in effective amount up to 0.5% by weight of the HFO and HFC refrigerant as disclosed in each of U.S. Patent Publication Nos. US20210108119 and US202100430368, each disclosure of which is hereby incorporated herein by reference in its entirety. Such inhibitor comprises at one of d-limonene, I-limonene, β-pinene, α-pinene, α-terpinene, β-terpinene, γ-terpinene, and δ-terpinene, and mixtures of two or more, a C₂-C₅ hydrocarbons, a xylene (ortho-, meta-para-), and mixtures of two or more as disclosed in U.S, Provisional Application Nos. 63/321,118 and 63/321,120, filed on Mar. 18, 2022, each disclosure of which is hereby incorporated herein by reference in its entirety.

One embodiment disclosed herein provides a reclaiming process comprising one or more of the following steps:
a) providing an unreclaimed refrigerant composition including at least one component selected from HFC-32, HFC-134, HFC-134a, HFC-125, HFC-143a, HFC-152a, HFC-227ea, HFO-1234yf, HFO-Z/E-1234ze, HFO-E-1225ye, HFO-Z/E-1336mzz, HCO-1130 (E), HFO-1123, and HFO-E/Z-1132;
b) (1) weighing and testing the un-reclaimed refrigerant composition of step a) comprising at least one of the refrigerant components, contaminants, non-condensable gases (NCG), and physical properties, and (2) checking and comparing the purity of the un-reclaimed refrigerant composition relative to AHRI 700 standards;
c) selecting physical and/or chemical treatments in accordance with data obtained from step b) and treating and purifying the un-reclaimed refrigerant composition of step b) and providing at least one first treated product;
d) checking the purity of the at least one first treated product of step c) and determining whether or not the first treated product meets or exceeds AHRI 700 standards;
e) optionally (1) adding additional refrigerant components to the first treated product to form a first target refrigerant or refrigerant blend if the first treated product meets or exceeds AHRI 700 standards, or (2) further purifying the first treated product when it does not meet AHRI 700 standards to produce a second treated product and check the purity of the second treated product to determine if it meets or exceeds AHRI 700 standards;
f) optionally adding additional refrigerant components to the second treated product if it meets or exceeds AHRI 700 standards to form a second target refrigerant or refrigerant blend;
g) optionally adding an effective amount of (1) at least one oligomer inhibitor pair selected from propane and limonene, propane and pinene, cyclopropane and limonene, cyclopropane and pinene, and a xylene and one of limonene, pinene or terpinene, optionally adding (2) at least one tracer selected from HFO-Z/E-1336mzz, HFO-1233zd, HFO-1224 yd, HFO-1112, HFO-1327, HFO-1336yf, HFO-1336ze, and HFC-263fb, to the first and/or second target refrigerant or refrigerant blends of step e) and or f) with the proviso that the refrigerant component and tracer are not the same.

In another embodiment, the inhibiting additive (alternatively “inhibitor” or “additive”) is added to compositions containing at least HFO-1234yf and comprises a pair of inhibitors one of which is limonene or pinene, wherein the inhibitor is present in amounts up to about 0.5 wt. %, less than 0.5 wt. % but greater than 0, e.g., 0.001 wt. %, 0.005 wt. %, 0.01 wt. %, 0.015 wt. %, 0.02 wt. %, 0.03 wt. %, 0.04 wt. %, 0.05 wt. % (500 ppm), 0.06 wt. %, 0.07 wt. %, 0.08 wt. %, 0.09 wt. %, 0.1 wt. % (1000 ppm), 0.2 wt. %, 0.3 wt. % (3000 ppm) 0.4 wt. %, 0.5, and all values therebetween, but present in amount sufficient to keep the formation of oligomeric, homopolymeric or other polymeric products less than about 0.03 wt. %, or provide a composition free of oligomeric, homopolymeric or other polymeric product.

In one embodiment of the invention, limonene or α-terpinene optionally with an antioxidant has a unique fragrance even at a few ppm level. This pleasant odor can be utilized for refrigerant leakage detection with refrigerant and blends based on hydrofluoroolefins (e.g., comprising at least one of HFO-1234yf, HFO-1234ze and combinations thereof). This is especially beneficial for early refrigerant leakage detection in household air conditioner or mobile air conditioner as paraprofessional electronic leak detectors often are not available in either location.

In another embodiment disclosed herein, the oligomer inhibiting stabilizer includes at least two inhibiting agents, i.e., pairs, including one of limonene, pinene, terpinene and one of ethane, propane, cyclopropane, propylene, butane, butene, isobutane and isobutene.

In another embodiment disclosed herein, oligomer inhibitor pairs where one component is selected from at least one of a C₂-C₅ hydrocarbon and the other component is selected from d-limonene, I-limonene, β-pinene, α-pinene, α-terpinene, β-terpinene, γ-terpinene, and δ-terpinene, and mixtures of two or more, including but not limited to up to 0.1 weight percent of: d-limonene/propane, I-limonene/propane, β-pinene/propane, α-pinene/propane, α-terpinene/propane, β-terpinene/propane, γ-terpinene/propane, and δ-terpinene/propane, d-limonene/cyclopropane, I-limonene/cyclopropane, β-pinene/cyclopropane, α-pinene/cyclopropane, α-terpinene/cyclopropane, β-terpinene/cyclopropane, γ-terpinene/cyclopropane, and δ-terpinene/cyclopropane, d-limonene/butane, I-limonene/butane, β-pinene/butane, α-pinene/propane, α-terpinene/butane, β-terpinene/butane, γ-terpinene/butane, and δ-terpinene/butane, d-limonene/isobutane, I-limonene/isobutane, β-pinene/isobutane, α-pinene/isobutane, α-terpinene/isobutane, β-terpinene/isobutane, γ-terpinene/isobutane, and δ-terpinene//isobutane, d-limonene/butene, I-limonene/butene, β-pinene/butene, α-pinene/butene, α-terpinene/butene, β-terpinene/butene, γ-terpinene/butene, or δ-terpinene/butene, where isobutane can be replaced by isobutene, or r d-limonene/xylene; or I-limonene/xylene; or β-pinene/xylene; or α-pinene/xylene; or α-terpinene/xylene; or β-terpinene/xylene; or γ-terpinene/xylene; or and δ-terpinene/xylene with the proviso that the xylene may be at least one of ortho-, meta- or para-xylene.

Another embodiment of the invention relates to any of the foregoing inhibitors added to the reclaimed refrigerant compositions in amounts of up to about 0.5 wt. %, less than 0.5 wt. % but greater than 0, e.g., 0.001 wt. %, 0.005 wt. %, 0.01 wt. %, 0.015 wt. %, 0.02 wt. % 0.03 wt. %, 0.04 wt. %, 0.05 wt. % (500 ppm), 0.06 wt. %, 0.07 wt. %, 0.08 wt. %, 0.09 wt. %, 0.1 wt. % (1000 ppm), 0.2 wt. %, 0.3 wt. % (3000 ppm) 0.4 wt. % and up to 0.5 wt. %, and all values therebetween, but present in amount sufficient to keep the formation of oligomeric, homopolymeric or other polymeric products less than about 0.03 wt. %, or provide a composition free of oligomeric, homopolymeric or other polymeric products.

The instant invention employs effective amounts of at least one of the foregoing oligomerization/homopolymerization inhibitors described herein. While any suitable effective amount can be employed, effective amounts comprise from about 0.001 weight percent to about 0.5 weight percent (5000 ppm), about 0.01 weight percent to about 0.5 weight percent, 0.01 weight percent (100 ppm) to about 0.4 weight percent, 0.01 weight percent to about 0.3 weight percent, about 0.01 weight percent to about 0.2 weight percent, 0.01 weight percent to about 0.1 weight percent (1000 ppm), all ranges and values therebetween, based on the total weight of refrigerant compositions. In one embodiment, an effective amount comprises about 10 to about 2,000 ppm by weight, about 10 to about 1,000 ppm and in some cases about 10 to about 500 ppm, or about 400 ppm, or about 300 ppm, or about 200 ppm, about 100 to 500 ppm, about 100 ppm to about 2000 ppm or about 1000 ppm, and all ranges therebetween of the at least one oligomerization/homopolymerization inhibitor which comprises at least one of limonene, pinene, terpinene and mixtures thereof.

In another embodiment, the inhibiting additive (alternatively “inhibitor” or “additive”) of HFO-1234yf comprises a pair of inhibitors in which one is selected from a C₂-C₅ hydrocarbon and the other is selected from limonene or pinene, and present in amounts up to about 0.5 wt. %, less than 0.5 wt. % but greater than 0, e.g., 0.001 wt. %, 0.005 wt. %, 0.01 wt. %, 0.015 wt. %, 0.02 wt. %, 0.03 wt. %, 0.04 wt. %, 0.05 wt. % (500 ppm), 0.06 wt. %, 0.07 wt. %, 0.08 wt. %, 0.09 wt. %, 0.1 wt. % (1000 ppm), 0.2 wt. %, 0.3 wt. % (3000 ppm) 0.4 wt. %, and up to 0.5 wt. %, and all values therebetween, but present in amount sufficient to keep the formation of oligomeric, homopolymers or other polymeric products less than about 0.03 wt. %, or provide a composition free of oligomeric, homopolymeric or other polymeric products.

The tracer may be a single compound or two or more tracer compounds which is/are added to the reclaimed compositions. The tracer comprises at least one of HFO-E-1336mzz, HCFO-1233zd, 1224 yd, CFO-1112, HFO-1123, HFO-1327, HFO-Z-1336mzz, and HFC-263fb. In some embodiments, the tracer is present in the compositions at a total concentration of about 1 part per million by weight (ppm) to about 5000 ppm, based on the weight of the total composition. In other embodiments, the tracer is present at a total concentration of about 10 ppm to about 1000 ppm. In other embodiments, the tracer is present at a total concentration of about 20 ppm to about 500 ppm. In other embodiments, the tracer is present at a total concentration of about 25 ppm to about 500 ppm. In other embodiments, the tracer is present at a total concentration of about 50 ppm to about 500 ppm. Alternatively, the tracer is present at a total concentration of about 100 ppm to about 300 ppm.

In some embodiments of the disclosed invention, system 110 collects used or unreclaimed HFO-1234yf, HFO-Z/E-1234ze, HFO-E/Z-1336mzz, or HFO-1234yf and HFO-Z/E-1234ze refrigerants or refrigerant blends and transfers them to system 120 for weighing, testing and an initial purity check. Thereafter, system 110 transfers the weighed and tested used or unreclaimed HFO-1234yf, or HFO-Z/E-1234ze, or HFO-1234yf and HFO-Z/E-1234ze refrigerant or refrigerant blend to the primary purification system 130 to obtain individual HFO-1234yf and/or HFO-Z/E-1234ze components using distillation and/or adsorption-desorption separation and or cryogenic cooling, and to check the purity of HFO-1234yf and/or HFO-Z/E-1234ze components. The separated and purified HFO-1234yf and/or HFO-Z/E-1234ze components are then transferred to either system 140 or system 150 for further purification in system 140, or for adjusting the HFO-1234yf and/or HFO-Z/E-1234ze content to an AHRI compliant targeted HFO-1234yf and/or HFO-Z/E-1234ze composition in system 150, and then the target compliant HFO-1234yf and/or HFO-Z/E-1234ze composition is transferred to system 160 which adds up to 0.1 weight percent, or up to 0.2 weight percent, or up to 0.3 weight percent of an inhibitor selected from limonene, pinene, terpinene, d-limonene/propane; or I-limonene/propane; or β-pinene/propane; or α-pinene/propane; or α-terpinene/propane; or β-terpinene/propane; or γ-terpinene/propane; or β-terpinene/propane; or d-limonene/cyclopropane; or I-limonene/cyclopropane; or β-pinene/cyclopropane; or α-pinene/cyclopropane; or α-terpinene/cyclopropane; or β-terpinene/cyclopropane; or γ-terpinene/cyclopropane; or δ-terpinene//cyclopropane, or d-limonene/xylene; or I-limonene/xylene; or β-pinene/xylene; or α-pinene/xylene; or α-terpinene/xylene; or β-terpinene/xylene; or γ-terpinene/xylene; or and δ-terpinene/xylene, with the proviso that xylene may be orthro, meta- or para-.

In other embodiments of the disclosed invention, system 100 collects used or unreclaimed HFO-1234yf, or HFO-Z/E-1234ze, or HFO-1234yf and HFO-Z/E-1234ze blend refrigerants at station 110, transfers the used or unreclaimed HFO-1234yf, or HFO-Z/E-1234ze, or HFO-1234yf and HFO-Z/E-1234ze blend refrigerant to system 120 for weighing, testing and an initial purity check, and then transfers the weighed and tested used or unreclaimed HFO-1234yf, or HFO-Z/E-1234ze, or HFO-1234yf and HFO-Z/E-1234ze blend refrigerant to the primary purification system 130 to obtain individual HFO-1234yf and/or HFO-Z/E-1234ze components using distillation and/or adsorption-desorption separation and or cryogenic cooling and to check the purity of HFO-1234yf and/or HFO-Z/E-1234ze components. System 130 then transfers the separated HFO-1234yf and/or HFO-Z/E-1234ze to either system 140 or system 150 for further purification in system 140 or adjusting the HFO-1234yf and/or HFO-Z/E-1234ze content to an AHRI compliant targeted HFO-1234yf and/or HFO-Z/E-1234ze refrigerant in system 150, and then transfers the target compliant HFO-1234yf and/or HFO-Z/E-1234ze to system 160 which adds a total concentration of about 1 part per million by weight (ppm) to about 5000 ppm, based on the weight of the total composition; or adds a total concentration of about 10 ppm to about 1000 ppm; or adds a total concentration of about 20 ppm to about 500 ppm; or a total concentration of about 25 ppm to about 500 ppm; or at a total concentration of about 50 ppm to about 500 ppm; or a total concentration of about 100 ppm to about 300 ppm of HFO-E-1336mzz; or HCFO-1233zd; or HFO-1224 yd; or CFO-1112; or HFO-1123; or HFO-1327; or HFO-Z-1336mzz; or HFO-1336yf; or HFO-1336ze; or, HFC-263fb.

In other embodiments of the disclosed invention, system 100 collects used or unreclaimed HFO-1234yf, or HFO-Z/E-1234ze, or HFO-1234yf and HFO-Z/E-1234ze blend refrigerant at station 110; transfers the used or unreclaimed HFO-1234yf, or HFO-Z/E-1234ze, or HFO-1234yf and HFO-Z/E-1234ze blend refrigerant to system 120 for weighing, testing and an initial purity check; transfers the weighed and tested used or unreclaimed HFO-1234yf, or HFO-Z/E-1234ze, or HFO-1234yf and HFO-Z/E-1234ze blend refrigerant to the primary purification system 130 to obtain individual HFO-1234yf and/or HFO-Z/E-1234ze components using distillation and/or adsorption-desorption separation and or cryogenic cooling and checking the purity of HFO-1234yf and/or HFO-Z/E-1234ze components; transfers the separated HFO-1234yf and/or HFO-Z/E-1234ze to either system 140 or system 150 for further purification in system 140 or adjusting of the HFO-1234yf and/or HFO-Z/E-1234ze content to an AHRI compliant targeted HFO-1234yf and/or HFO-Z/E-1234ze refrigerant in system 150; and then transfers the target compliant HFO-1234yf and/or HFO-Z/E-1234ze to system 160 which adds up to 0.1 weight percent, or up to 0.2 weight percent or up to 0.3 weight percent of limonene/propane; or I-limonene/propane; or β-pinene/propane; or α-pinene/propane; or α-terpinene/propane; or β-terpinene/propane; or γ-terpinene/propane; or δ-terpinene/propane; or d-limonene/cyclopropane; or I-limonene/cyclopropane; or β-pinene/cyclopropane; or α-pinene/cyclopropane; or α-terpinene/cyclopropane; or β-terpinene/cyclopropane; or γ-terpinene/cyclopropane; or δ-terpinene//cyclopropane, and which adds a tracer content, based on the total weight of the HFO-1234yf and/or HFO-Z/E-1234ze, about 1 part per million by weight (ppm) to about 5000 ppm; or about 10 ppm to about 1000 ppm; or about 20 ppm to about 500 ppm; or about 25 ppm to about 500 ppm; or about 50 ppm to about 500 ppm; or about 100 ppm to about 300 ppm of HFO-E-1336mzz; or HCFO-1233zd; or HFO-1224 yd; or CFO-1112; or HFO-1123; or HFO-1327; or HFO-Z-1336mzz; or HFO-1336yf; or HFO-1336ze; or, HFC-263fb.

In still other embodiments of the disclosed invention, system 110 collects used or unreclaimed HFC-32, HFC-125 and HFO-1234yf blends; or HFC-32 and HFO-1234yf blends; or HFO-1234yf, HFC-32, and HFC-125 blends; HFC-134a and HFO-Z/E-1234ze blends; or HFO-1234yf, HFC-32, HFC-125 and HFC-134a blends and transfers the collected used or unreclaimed blend to system 120 for weighing, testing and an initial purity check, and then transfers the weighed and tested used or unreclaimed blend to the primary purification system 130 to obtain individual refrigerant components, HFO-1234yf and/or HFC-32 and/or HFC-134a and or HFC-125 and/or HFO-Z/E-1234ze using distillation; and/or adsorption-desorption separation; and or cryogenic cooling and checking the purity of individual components, and then transfers the individual components to either system 140 or system 150 for further purification in system 140 or adjusting of the HFO-1234yf and/or HFC-32 and/or HFC-134a and/or HFC-125 and/or HFO-Z/E-1234ze content to an AHRI compliant targeted component or blend including adding virgin HFO-1234yf and/or HFC-32 and/or HFC-134a and/or HFC-125 and/or HFO-Z/E-1234ze in system 150, and then transferring the target compliant HFO-1234yf and/or HFC-32 and/or HFC-134a and/or HFC-125 refrigerant or refrigerant blend to system 160 which adds up to 0.1 weight percent, or up to 0.2 weight percent or up to 0.3 weight percent of ethane; or propane; or propylene; or butane; or butene; or isobutene; or limonene/propane; or I-limonene/propane; or β-pinene/propane; or α-pinene/propane; or α-terpinene/propane; or β-terpinene/propane; or γ-terpinene/propane; or α-terpinene/propane; or d-limonene/cyclopropane; or I-limonene/cyclopropane; or β-pinene/cyclopropane; or α-pinene/cyclopropane; or α-terpinene/cyclopropane; or β-terpinene/cyclopropane; or γ-terpinene/cyclopropane; or δ-terpinene//cyclopropane, and/or adds about 1 part per million by weight (ppm) to about 5000 ppm, or about 10 ppm to about 1000 ppm; or about 20 ppm to about 500 ppm; or about 25 ppm to about 500 ppm; or about 50 ppm to about 500 ppm; or about 100 ppm to about 300 ppm of HFO-E-1336mzz; or HCFO-1233zd; or HFO-1224 yd; or CFO-1112; or HFO-1123; or HFO-1327; or HFO-Z-1336mzz; or HFO-1336yf; or HFO-1336ze; or, HFC-263fb.

In still other embodiments, system 110 collects used or unreclaimed R404A (ASHRAE designation for a blend of 44 weight percent R125, 52 weight percent R143a (1,1,1-trifluoroethane), and 4.0 weight percent R134a); or unreclaimed R407A, R407B, R407C, R407D, and R407E (ASHRAE designations for blends of R134a, R125 (pentafluoroethane), and R32 (difluoromethane) in differing component concentrations); or unreclaimed R408A (ASHRAE designation for a blend of 7 weight percent R125, 46 weight percent R143a, and 47 weight percent R22); or unreclaimed R410A (ASHRAE designation for a blend of 50 weight percent R125 and 50 weight percent R32); or unreclaimed R413A (ASHRAE designation for a blend containing R218, R134a, and isobutane); R417A, (ASHRAE designation for a blend of 46.6 weight percent R125, 50.0 weight percent R134a, and 3.4 weight percent n-butane); or unreclaimed R419A (ASHRAE designation for a blend containing R125, R134a and DME); or R422A, R422B, R422C and R422D, (ASHRAE designation for blends of R125, R134a, isobutane in differing component concentrations), or unreclaimed R423A (ASHRAE designation for a blend containing R134a and 1,1,1,2,3,3,3-heptafluoropropane (R227ea); or unreclaimed R424A (ASHRAE designation for a blend containing R125, R134a, isobutane, n-butane, and isopentane); or unreclaimed R426A (ASHRAE designation for a blend containing R125, R134a, n-butane, and isopentane); or unreclaimed R427A (ASHRAE designation for a blend of 15 weight percent R32, 25 weight percent R125, 50 weight percent R134a, and 10 weight percent R143a); or unreclaimed R428A (ASHRAE designation for a blend containing R125, R143a, propane and isobutane); or unreclaimed R430A (ASHRAE designation for a blend containing R152a and isobutane); or unreclaimed R434A (ASHRAE designation for a blend containing R125, R134a, R143a, and isobutane); unreclaimed R-463A (ASHRAE designation for blends of R-744/32/125/1234yf/134a (6.0/36.0/30.0/14.0/14.0)); or unreclaimed R437A (ASHRAE designation for a blend containing R125, R134a, n-butane, and n-pentane); or unreclaimed R438A (ASHRAE designation for a blend containing R32, R125, R134a, n-butane, and isopentane); or unreclaimed R507A and R507B (ASHRAE designation for a blend of R125 and R143a in differing component concentrations); or unreclaimed R508A and R508 (ASHRAE designations for blends of trifluoromethane (R23) and hexafluoroethane (R116) in differing component concentrations) and processes any of the used unreclaimed blends in systems 120-140 to form reclaimed refrigerant components, which are reconstituted in system 150 where fresh or virgin refrigerant is added, and made stable and traceable in system 160 which adds up to 0.1 weight percent, or up to 0.2 weight percent or up to 0.3 weight percent of ethane; or propane; or propylene; or butane; or butene; or isobutene; or limonene/propane; or I-limonene/propane; or β-pinene/propane; or α-pinene/propane; or α-terpinene/propane; or β-terpinene/propane; or γ-terpinene/propane; or δ-terpinene/propane; or d-limonene/cyclopropane; or I-limonene/cyclopropane; or β-pinene/cyclopropane; or α-pinene/cyclopropane; or α-terpinene/cyclopropane; or β-terpinene/cyclopropane; or γ-terpinene/cyclopropane; or δ-terpinene//cyclopropane, and/or adding a total concentration of about 1 part per million by weight (ppm) to about 5000 ppm, based on the weight of the total composition about 10 ppm to about 1000 ppm; or about 20 ppm to about 500 ppm; or about 25 ppm to about 500 ppm; or about 50 ppm to about 500 ppm; or about 100 ppm to about 300 ppm of HFO-E-1336mzz; or HCFO-1233zd; or HFO-1224 yd; or CFO-1112; or HFO-1123; or HFO-1327; or HFO-Z-1336mzz; or HFO-1336yf; or HFO-1336ze; or, HFC-263fb.

### Other Embodiments

Process embodiment 1 comprises one of more of steps a)-g); or all of steps a)-g); or at least step a) and step b), wherein steps a)-g) comprise:
a) providing a used or unreclaimed fluoroolefin refrigerant composition which includes hydrofluorocarbon refrigerant component: HFC-32; HFC-134a; HFC-125; HFC-143a; HFC-152a; or HFC-227ea; and fluoroolefin components HFO-1234yf; HFO-Z/E-1234ze; HFO-E/Z-1336mzz, HFO-E/Z-1225ye; Z/E-HFO-1132, HFO-1123; or HFO-1234yf and HFO-Z/E-1234ze blends; or HFO-1234y and Z/E-1225ye; or HFO-1234yf and HFO-Z/E-1132E blends; or HFO-Z/E-1336mzz and HFO-Z/E-1234ze blends;)
b) weighing and testing an unreclaimed refrigerant or blend of step a) and identify at least one of the refrigerant components, contaminants, non-condensable gases (NCG), physical properties, and checks and compares the purity of the unreclaimed refrigerant or blend relative to AHRI 700 standards, and if unreclaimed refrigerant or blend of step a) does not meet the AHRI 700 standards;
c) selecting at least one or all of the physical and/or chemical treatments in accordance with step b) and treating and purifying the unreclaimed refrigerant or blend of step b) and providing at least one first refrigerant product;
d) checking the purity of the at least one first treated refrigerant product of step c) and determining whether or not the first treated refrigerant product meets or exceeds AHRI 700 standards;
e) (1) adding additional refrigerant components to the first treated refrigerant product to form a first target refrigerant or refrigerant blend if the first treated refrigerant product meets or exceeds AHRI 700 standards, or (2) further purifying the first treated refrigerant product does not meet AHRI 700 standards to produce a second treated product and check the purity of the second treated product to determine if it meets or exceeds AHRI 700 standards;
f) adding additional refrigerant components to the second treated product if it meets or exceeds AHRI 700 standards to form a second target refrigerant or refrigerant blend;)
g) add an effective amount of (1) at least one oligomer inhibitor from ethane and/or propane and/or cyclopropane and/or limonene or pinene and/or propane and limonene, propane and pinene, cyclopropane and limonene, and cyclopropane and/or pinene and/or at least one tracer from HFO-Z/E-1336mzz and/or HFO-1233zd and/or HFO-1224 yd and/or HFO-1112 and/or HFO-1327 and/or HFO-1336yf and/or HFO-1336ze and/or and HFC-263fb to the first and/or second target refrigerant or refrigerant blends of step e) and or f) with the proviso that the refrigerant/component/compound and tracer are not the same.

Process embodiment 2 includes comprises,
a) providing a used or unreclaimed fluoroolefin refrigerant composition which includes hydrofluorocarbon refrigerant: HFC-32; HFC-134a; HFC-125; HFC-143a; HFC-152a; or HFC-227ea; and fluoroolefins HCO-1132; HFO-1234yf; HFO-Z/E-1234ze; HFO-E/Z-1336mzz; HFO-Z/E-1225ye; or Z/E-HFO-1132; or HFO-1234yf and HFO-Z/E-1234ze blends; or HFO-1234y and Z/E-1225ye; or HFO-1234yf and Z/E-HFO-1132 blends; or Z/E-HFO-1234ze blends,
b) weighing and testing an unreclaimed refrigerant or blend of step a) comprising at least one of the refrigerant components, contaminants and non-condensable gases (NCG), physical properties, and checking and comparing the purity of the unreclaimed refrigerant or blend relative to AHRI 700 standards; and if unreclaimed refrigerant or blend of step a) does not meet the AHRI 700 standards;
c) optionally selecting physical and/or chemical treatments in accordance with step b) and treating and purifying the unreclaimed refrigerant or blend of step b) and providing at least one first refrigerant product;
d) checking the purity of the at least one first treated refrigerant product of step c) and determining whether or not the first treated refrigerant product meets or exceeds AHRI 700 standards;
e) if necessary (1) adding additional refrigerant components to the first treated refrigerant product to form a first target refrigerant or refrigerant blend if the first treated refrigerant product meets or exceeds AHRI 700 standards, or (2), further purifying the first treated refrigerant product does not meet AHRI 700 standards to produce a second treated product and check the purity of the second treated product to determine if it meets or exceeds AHRI 700 standards;
f) optionally, adding additional refrigerant components to the second treated product if it meets or exceeds AHRI 700 standards to form a second target refrigerant or refrigerant blend;
g) optionally add an effective amount of (1) at least one oligomer inhibitor from ethane and/or propane and/or cyclopropane and/or limonene or pinene and/or propane and limonene, propane and pinene, cyclopropane and limonene, and cyclopropane and/or pinene and/or at least one tracer from HFO-Z/E-1336mzz and/or HFO-1233zd and/or HFO-1224 yd and/or HFO-1112 and/or HFO-1327 and/or HFO-1336yf and/or HFO-1336ze and/or and HFC-263fb to the first and/or second target refrigerant or refrigerant blends of step e) and or f) with the proviso that refrigerant and tracer are not the same.

The process embodiment 1 or 2 wherein an oligomer inhibitor is added or an effective amount of the oligomer inhibitor to keep the formation of oligomeric, homopolymers or other polymeric products at a level that is less than about 0.03 wt. %.

The process embodiment 1 or 2 wherein an effective amount of the oligomer inhibitor to keep the first and/or second target refrigerant or refrigerant blends of step e) and or f) free of oligomeric, homopolymers or other polymeric products is added.

The process embodiment 1 or 2 wherein an oligomer inhibitor is added and comprises at least one of ethane, propane, cyclopropane, and limonene or pinene, and/or a tracer is added.

The process embodiment 1 or 2 wherein the added oligomer inhibitor comprises: up to about 0.5 wt. %; or less than 0.5 w/t % but greater than 0; or from 0.001 wt. % and 0.005 wt. %; or from 0.01 wt. % up to one of 0.015 wt. %, 0.02 wt. % 0.03 wt. %, 0.04 wt. %, 0.05 wt. %, 0.06 wt. %, 0.07 wt. %, 0.08 wt. %, 0.09 wt. %, and 0.1 wt. %; or from 0.2 wt. % to one of 0.3 wt. % (3000 ppm), 0.4 wt. %, and up to 0.5 wt. %.

The process embodiment 1 or 2 wherein at least one tracer is added and comprises: about 10 ppm to about 1000 ppm; or about 20 ppm to about 500 ppm; or about 25 ppm to about 500 ppm; or about 50 ppm to about 500 ppm; or about 100 ppm to about 300 ppm, wherein “about” is ±1%, ±2%, ±3% and up to and including ±10% of the ppm amount.

The process embodiment 1 or 2 wherein used or unreclaimed fluoroolefin refrigerant composition comprises HFO-1234yf or HFO-Z/E-1234ze or 1 to 99 percent by weight HFO-1234yf and 99 to about 1 percent by weight HFO-Z/E-1234ze.

The process embodiment 1 or 2 wherein the used or unreclaimed HFO-1234yf or HFO-Z/E-1234ze fluoroolefin refrigerant composition also comprises HFC-32, and/or HFC-134 and/or HFC-134a and/or HFC-32 and HFC-134a, and/or HFC-125.

The process embodiment 1 or 2 wherein the used and unreclaimed refrigerant or refrigerant blend comprises HFC-32; or HFC-32 and HFC-125, or HFC-134, HFC-125 and HFC-32, or HFC-134a and HFC-125; or HFO-1234yf; or HFO-Z/E-1234ze; or HFO-1234yf and HFO1234ze; or HFO-1234yf and at least one of HFC-32, HFC-134a, HFC-125, HFC-152a and CO₂ (R744); or HFO-Z/E-1234ze and at least one of HFC-32, HFC-134a, and HFC-125; or HFO-1234yf, HFO-Z/E-1234ze and at least one of HFC-32, HFC-134a, and HFC-125.

The process embodiment 1 or 2 wherein an oligomer inhibitor is added and comprises a pair of inhibitors comprising propane and limonene or pinene or a xylene and limonene or pinene.

The process embodiment 1 or 2 wherein the testing of step b) includes GC-FID and/or GC-TCD and/or GC-MS and/or FTIR and/or Goetz Bub and/or Karl Fischer and/or, Byk-Garner Color and/or acidity test and/or moisture and/or NAG.

The process embodiment 1 wherein the testing of step b) includes GC-MS, FTIR, acidity, moisture, and NAG testing.

The process embodiment 1 or 2 wherein system 120 includes NAG testing by using infrared sensors, or UV sensors, or NIR sensors, or ion mobility or plasma chromatographs or high temperature thick film sensors or thin film field effect sensors or pellistor sensors or Taguchi sensors or quartz microbalance sensors.

The process embodiment 1 or 2 comprises distillation and/or adsorption and/or desorption and/or cryogenic cooling, and steps e) or f) comprises NAG purging and/or water removal by distillation and/or desiccant drying and/or a solids filter and/or acidity neutralization and/or high boiling residue/chloride distillation.

The process embodiment 1 step f) comprises separating and purifying HFO-1234yf and HFO-Z/E-1234ze; or HFO-1234yf, HFO-Z/E-1234ze and HFO-Z/E-1225ye; or HFO-1234yf, HFO-Z/E-1234ze, HFO-Z/E-1225ye and Z/E-HFO-1132, or HFO1234ze (E) and HFO-1336mzz (E).

The process embodiment 1 step f) comprises separating and purifying HFO-1234yf; or HFO-Z/E-1234ze; or E-1225ye; or Z/E-HFO-1132; or HFO-1132a, or HFO-1336mzz (E); or HFO-1336mzz (Z); HFC-152a; or HFC-134a; or HFC-32; or HFC-125; or HFC-143a; or HFC-227ea; or CH₃I; or HFC-32 and HFC-134a; or HFC-32, HFC-134a and HFC-125; or HFO-1234yf and Z/E-HFO-1234ze; or HFO-1234yf, HFO-1336mzz (E) and HFO-1234ze (E).

Composition embodiment 1 of the disclosed invention is a reclaimed-reconstituted, stabilized and traceable refrigerant composition comprising reclaimed-reconstituted, stabilized and traceable HFC-32; or reclaimed-reconstituted, stabilized and traceable HFC-32 and HFC-125, or reclaimed-reconstituted, stabilized and traceable HFC-134 and HFC-125, or reclaimed-reconstituted, stabilized and traceable HFC-32, or HFC-134a and HFC-125; or HFO1234yf; or Z/E-HFO-1234ze; or HFO-1234yf and Z/E-HFO-1234ze with propane; or cyclopropane; or propylene; or butane; or butane; or isobutene, or a xylene selected from one of meta-; or ortho-; or para-xylene; or d-limonene; or I-limonene; or β-pinene; or α-pinene; or α-terpinene; or β-terpinene; or γ-terpinene; or and δ-terpinene; or d-limonene/propane; or I-limonene/propane; or β-pinene/propane; or α-pinene/propane; or α-terpinene/propane; or β-terpinene/propane; or γ-terpinene/propane; or and δ-terpinene/propane; or d-limonene/cyclopropane; or I-limonene/cyclopropane; or β-pinene/cyclopropane; or α-pinene/cyclopropane; or α-terpinene/cyclopropane; or β-terpinene/cyclopropane; or γ-terpinene/cyclopropane; or δ-terpinene//cyclopropane; or d-limonene/butane; or I-limonene/butane; or β-pinene/butane; or α-pinene/propane; or α-terpinene/butane; or β-terpinene/butane; or γ-terpinene/butane; or and δ-terpinene/butane; or d-limonene/isobutane; or I-limonene/isobutane; or β-pinene/isobutane; or α-pinene/isobutane; or α-terpinene/isobutane; or β-terpinene/isobutane; or γ-terpinene/isobutane; or and δ-terpinene//isobutane; or d-limonene/butene; or I-limonene/butene; or β-pinene/butene; or α-pinene/butene; or α-terpinene/butene; or β-terpinene/butene; or γ-terpinene/butene; or δ-terpinene/butene and with HFO-Z/E-1336mzz; or HFO-1233zd; or HFO-1224 yd; or HFO-1112; or HFO-1327; or HFO-1336yf; or HFO-1336ze; or HFC-263fb.

Composition embodiment 1 of the disclosed invention is a reclaimed-reconstituted, stabilized and traceable refrigerant composition which includes, based on the total weight of the reclaimed-reconstituted refrigerant or refrigerant blend up to about 0.5 wt. %; or less than 0.5 w/t % but greater than 0; or from 0.001 wt. % and 0.005 wt. %; or from 0.01 wt. % up to one of 0.015 wt. %, 0.02 wt. % 0.03 wt. %, 0.04 wt. %, 0.05 wt. %, 0.06 wt. %, 0.07 wt. %, 0.08 wt. %, 0.09 wt. and %, 0.1 wt. %; or from 0.2 wt. % to one of 0.3 wt. % (3000 ppm), 0.4 and wt. % 0.5. of propane; or cyclopropane; or propylene; or butane; or butane; or isobutene, a xylene selected from one of meta-; or ortho-; or para-xylene; or d-limonene; or I-limonene; or β-pinene; or α-pinene; or α-terpinene; or β-terpinene; or γ-terpinene; or and δ-terpinene; or d-limonene/propane; or I-limonene/propane; or β-pinene/propane; or α-pinene/propane; or α-terpinene/propane; or β-terpinene/propane; or γ-terpinene/propane; or and δ-terpinene/propane; or d-limonene/cyclopropane; or I-limonene/cyclopropane; or β-pinene/cyclopropane; or α-pinene/cyclopropane; or α-terpinene/cyclopropane; or β-terpinene/cyclopropane; or γ-terpinene/cyclopropane; or and δ-terpinene//cyclopropane; or d-limonene/butane; or I-limonene/butane; or β-pinene/butane; or α-pinene/propane; or α-terpinene/butane; or β-terpinene/butane; or γ-terpinene/butane; or and δ-terpinene/butane; or d-limonene/isobutane; or I-limonene/isobutane; or β-pinene/isobutane; or α-pinene/isobutane; or α-terpinene/isobutane; or β-terpinene/isobutane; or γ-terpinene/isobutane; or and δ-terpinene//isobutane; or d-limonene/butene; or I-limonene/butene; or β-pinene/butene; or α-pinene/butene; or α-terpinene/butene; or β-terpinene/butene; or γ-terpinene/butene; or δ-terpinene/butene and about 10 ppm to about 1000 ppm; or about 20 ppm to about 500 ppm; or about 25 ppm to about 500 ppm; or about 50 ppm to about 500 ppm; or about 100 ppm to about 300 ppm of HFO-Z/E-1336mzz; or HFO-1233zd; or HFO-1224 yd; or HFO-1112; or HFO-1327; or HFO-1336yf; or HFO-1336ze; or HFC-263fb, wherein optionally “about” is +1%, +2%, +3% and up to and including ±10% of the ppm value.

System embodiment 1 of the disclosed invention comprises an unreclaimed refrigerant recovery station; a weighing and testing station comprising analytical systems to determine physical and chemical properties of the unreclaimed refrigerant comprising refrigerant components, contaminants and non-condensable gases (NCG); a first purification system for receiving and treating unreclaimed refrigerant from said weighing and testing station, and first transport lines; optionally a second purification system for receiving and treating refrigerant from the first purification system, and second transport lines; a target refrigerant system in flow communication with the first and second transport lines to receive treated refrigerant from the first and second purification systems for adjusting levels of reclaimed refrigerant components to target refrigerant levels of the AHRI 700 standards following purification at said first and second purification stations, including a blending station to provide reclaimed refrigerant blends components consistent with AHRI 700 standards; an oligomer and tracer tank system respectively containing a supply of (1) propane; or cyclopropane; or propylene; or butane; or butane; or isobutene; or d-limonene; or I-limonene; or β-pinene; or α-pinene; or α-terpinene; or β-terpinene; or γ-terpinene; or and δ-terpinene; or d-limonene/propane; or I-limonene/propane; or β-pinene/propane; or α-pinene/propane; or α-terpinene/propane; or β-terpinene/propane; or γ-terpinene/propane; or and δ-terpinene/propane; or d-limonene/cyclopropane; or I-limonene/cyclopropane; or β-pinene/cyclopropane; or α-pinene/cyclopropane; or α-terpinene/cyclopropane; or β-terpinene/cyclopropane; or γ-terpinene/cyclopropane; or and δ-terpinene//cyclopropane; or d-limonene/butane; or I-limonene/butane; or β-pinene/butane; or α-pinene/propane; or α-terpinene/butane; or β-terpinene/butane; or γ-terpinene/butane; or and δ-terpinene/butane; or d-limonene/isobutane; or I-limonene/isobutane; or β-pinene/isobutane; or α-pinene/isobutane; or α-terpinene/isobutane; or β-terpinene/isobutane; or γ-terpinene/isobutane; or and δ-terpinene//isobutane; or d-limonene/butene; or I-limonene/butene; or β-pinene/butene; or α-pinene/butene; or α-terpinene/butene; or β-terpinene/butene; or γ-terpinene/butene; or δ-terpinene/butene and (2) HFO-Z/E-1336mzz; or HFO-1233zd; or HFO-1224 yd; or HFO-1112; or HFO-1327; or HFO-1336yf; or HFO-1336ze; or HFC-263fb; and, a purity check station to check the purity of unreclaimed refrigerant before purification, after the first and/or second purification treatments, and of the at least one first treated product of step c) and determining whether or not the first treated product meets or exceeds AHRI 700 standards,

System embodiment 1 of the invention includes a weighing and testing station include a scale and a GC-FID; or GC-TCD; or GC-MS; or FTIR; or Goetz Bub, or Karl Fischer, or Byk-Garner Color, or NCG detector.

System embodiment 1 includes a first and an optional second purification system either of which or both include one or more distillation columns; or one or more adsorption/desorption columns; one or more cryogenic coolers; or at least one distillation column and at least one adsorption/desorption columns and at least one cryogenic cooler; and NCG purge units; or a water distillation or desiccant dryer unit; or a solids filter unit; or acidity neutralizer; or a high distillation residue column.

Although certain aspects, embodiments and principals have been described above, it is understood that this description is made only way of example and not as limitation of the scope of the invention or appended claims. The foregoing various aspects, embodiments and principals can be used alone and in combinations with each other.

What is claimed is:

1. A process comprising the following steps:
a) providing an unreclaimed refrigerant composition including at least one component selected from the group consisting of HFC-32, HFC-134, HFC-134a, HFC-125, HFC-143a, HFC-152a, HFC-227ea, HFO-1234yf, HFO-Z/E-1234ze, E-1225ye, HFO-Z/E-1132 and HFO-E/Z-1336mzz, and mixtures of two or more thereof;)
(1) weighing and testing the unreclaimed refrigerant composition of step a) to determine at least one parameter selected from the group consisting of the refrigerant components, contaminants, non-condensable gases (NCG), and physical properties, and (2) checking and comparing the purity of the unreclaimed refrigerant composition relative to AHRI 700 standards and, if the unreclaimed refrigerant composition of step a) does not meet AHRI 700 standards, selecting physical and/or chemical treatments in accordance with data obtained from step b) (1) and treating and purifying the unreclaimed refrigerant composition of step b) (1) and providing at least one first treated product;
c) checking the purity of the at least one first treated product of step b) and determining whether or not the at least one first treated product meets or exceeds AHRI 700 standards;
d) optionally (1) adding at least one additional refrigerant component to the at least one first treated product to form a first target refrigerant or refrigerant blend if the at least one first treated product meets or exceeds AHRI 700 standards, or (2) further purifying the at least one first treated product if it does not meet AHRI 700 standards to produce a second treated product, and check the purity of the second treated product to determine if it meets or exceeds AHRI 700 standards;
e) optionally adding at least one additional refrigerant component to the second treated product if it meets or exceeds AHRI 700 standards to form a second target refrigerant or refrigerant blend; and
f) optionally adding an effective amount of (1) at least one oligomer inhibitor selected from the group consisting of ethane, propane, cyclopropane, limonene, pinene, both propane and limonene, both propane and pinene, both cyclopropane and limonene, and both cyclopropane and pinene, and/or (2) at least one tracer selected from the group consisting of HFO-Z/E-1336mzz, HFO-1233zd, HFO-1224 yd, HFO-1112, HFO-1327, HFO-1336yf, HFO-1336ze, and HFC-263fb, to the first and/or second target refrigerant or refrigerant blends of step d) and/or e) with the proviso that the at least one component and the at least one tracer are not the same.

2. The process as in claim 1, wherein an oligomer inhibitor is added.

3. The process as in claim 2, comprising:
adding an effective amount of the oligomer inhibitor to keep the formation of oligomeric, homopolymers or other polymeric products at a level that is less than about 0.03 wt. %; or
adding an effective amount of the oligomer inhibitor to keep the first and/or second target refrigerant or refrigerant blends of step d) and/or e) free of oligomeric, homopolymers or other polymeric products.

4. (canceled)

5. The process as in claim 2, wherein the oligomer inhibitor comprises at least one selected from the group consisting of ethane, propane, cyclopropane, limonene, and pinene.

6. (canceled)

7. The process as in claim 2, where the oligomer inhibitor comprises:
up to about 0.5 wt. %; or
less than 0.5 wt. % but greater than 0; or
from 0.001 wt. % and 0.005 wt. %; or
from 0.01 wt. % up to one of 0.015 wt. %, 0.02 wt. %, 0.03 wt. %, 0.04 wt. %, 0.05 wt. %, 0.06 wt. %, 0.07 wt. %, 0.08 wt. %, 0.09 wt. and %, 0.1 wt. %; or
from 0.2 wt. % to one of 0.3 wt. % (3000 ppm), 0.4 wt. % and 0.5 wt. %.

8. The process as in claim 1, wherein at least one tracer is added and comprises:
about 10 ppm to about 1000 ppm; or
about 20 ppm to about 500 ppm; or
about 25 ppm to about 500 ppm; or
about 50 ppm to about 500 ppm; or
about 100 ppm to about 300 ppm,
based on the total weight of the first and/or second target refrigerant or refrigerant blends.

9. The process as in claim 1, wherein the unreclaimed fluoroolefin refrigerant composition comprises at least one compound selected from the group consisting of HFO-1234yf, HFO-Z-1234ze, HFO-E-1234ze, HFC-32, HFC-134, HFC-134a and HFC-125.

10-13. (canceled)

14. The process as in claim 1, wherein the unreclaimed fluoroolefin refrigerant composition comprises HFC-32 and HFC-134a.

15. (canceled)

16. The process as in claim 1, wherein the unreclaimed refrigerant composition comprises:
HFC-32; or
HFC-32 and HFC-125, or
HFC-134 and HFC-125, HFC-32, or
HFC-134a and HFC-125; or
HFO1234yf; or
HFO-Z/E-1234ze; or
HFO-1234yf and HFO1234ze; or
HFO-1234yf and at least one of HFC-32, HFC-134a, HFC-125, HFC-152a and CO₂; or
HFO-Z/E-1234ze and at least one of HFC-32, HFC-134a, and HFC-125; or
HFO-1234yf, HFO-Z/E-1234ze and at least one of HFC-32, HFC-134a, and HFC-125.

17. The process as in claim 1, wherein an oligomer inhibitor is added and comprises a pair of inhibitors, preferably propane and one of limonene and pinene.

18-21. (canceled)

22. The process as in claim 1, wherein step b) comprises at least one of distillation, adsorption, desorption, and cryogenic cooling, and step f) comprises NAG purging, water removal by distillation and/or desiccant drying, solids filtration, acidity neutralization, and/or high boiling residue/chloride distillation.

23. The process as in claim 22, wherein the treatment or treatments of step b) also comprises at least one NAG purging, water removal by distillation and/or desiccant drying, solids filtration, acidity neutralization, and high boiling residue/chloride distillation, different from step c).

24. The process as in claim 1, wherein step f) comprises separating and purifying:
HFO-1234yf and HFO-Z/E-1234ze; or
HFO-1234yf, HFO-Z/E-1234ze, HFO-Z/E-1225ye; or
HFO-Z/E-1132; or
HFO-1234yf; or
HFO-Z/E-1234ze; or
E-1225ye; or
HFO-Z/E-1132; or
HFC-152a; or
HFC-134a; or
HFC-32; or
HFC-125; or
HFC-143a; or
HFC-227ea; or
CH₃I: or
HFC-32 and HFC-134a; or
HFC-32, HFC-134a and HFC-125.

25-31. (canceled)

32. A reclaimed refrigerant composition comprising,
a. at least one reclaimed refrigerant selected from the group consisting of: HFC-32; HFC-227ea; or HFC-32 and HFC-125, or HFC-134 and HFC-125, or HFC-134a and HFC-125; or HFO1234yf; or HFO-Z/E-1234ze; or HFO-E/Z-1336mzz, or HFO-1234yf and HFO1234ze; HFO1234ze and HFO-E/Z-1336mzz; or HFO-1234yf; or at least one of HFC-32, HFC-134a, and HFC-125; or HFO-Z/E-1234ze and at least one of HFC-32, HFC-134a, and HFC-125; or HFO-1234yf, HFO-Z/E-1234ze and at least one of HFC-32, HFC-134a, and HFC-125;
b. at least one oligomer inhibitor selected from the group consisting of d-limonene, I-limonene, β-pinene, α-pinene, α-terpinene, β-terpinene, γ-terpinene, and δ-terpinene, d-limonene/propane, I-limonene/propane, β-pinene/propane, α-pinene/propane, α-terpinene/propane, β-terpinene/propane, γ-terpinene/propane, and α-terpinene/propane, β-limonene/cyclopropane, I-limonene/cyclopropane, β-pinene/cyclopropane, α-pinene/cyclopropane, α-terpinene/cyclopropane, β-terpinene/cyclopropane, γ-terpinene/cyclopropane, and β-terpinene//cyclopropane, d-limonene/butane, I-limonene/butane, β-pinene/butane, α-pinene/propane, α-terpinene/butane, β-terpinene/butane, γ-terpinene/butane, and α-terpinene/butane, β-limonene/isobutane, I-limonene/isobutane, β-pinene/isobutane, α-pinene/isobutane, α-terpinene/isobutane, β-terpinene/isobutane, γ-terpinene/isobutane, and δ-terpinene//isobutane, d-limonene/butene, I-limonene/butene, β-pinene/butene, α-pinene/butene, α-terpinene/butene, β-terpinene/butene, γ-terpinene/butene, and δ-terpinene/butene; and
c. at least one tracer selected from the group consisting of HFO-Z/E-1336mzz, HFO-1233zd, HFO-1224 yd, HFO-1112, HFO-1327, HFO-1336yf, HFO-1336ze, and HFC-263fb, with the proviso that the at least one reclaimed refrigerant and the at least one tracer are not the same.

33. The reclaimed refrigerant composition as in claim 32, wherein the oligomer inhibitor comprises, based on the total weight of the refrigerant components:
up to about 0.5 wt. %; or
less than 0.5 wt. % but greater than 0; or
from 0.001 wt. % and 0.005 wt. %; or
from 0.01 wt. % up to one of 0.015 wt. %, 0.02 wt. %, 0.03 wt. %, 0.04 wt. %, 0.05 wt. %, 0.06 wt. %, 0.07 wt. %, 0.08 wt. %, 0.09 wt. %, and 0.1 wt. %;
or
from 0.2 wt. % to one of 0.3 wt. % (3000 ppm), 0.4 wt. %, and 0.5 wt. %.

34. (canceled)

35. A system comprising:
a. an unreclaimed refrigerant recovery station configured to receive an unreclaimed refrigerant;
b. a weighing and testing station comprising at least one analytical system configured to determine physical and chemical properties of the unreclaimed refrigerant, the physical and chemical properties comprising at least one property selected from the group consisting of refrigerant components, presence and/or content of contaminants, and presence and/or content of non-condensable gases (NCG);
c. a first purification system for receiving and treating the unreclaimed refrigerant from said weighing and testing station;
d. first transport lines;
e. a second purification system for receiving and treating refrigerant from the first purification system via the first transport lines;
f. second transport lines;
g. a target refrigerant system in flow communication with the first and second transport lines and configured to receive treated refrigerant from the first and second purification systems for adjusting levels of reclaimed refrigerant components to target refrigerant levels of the AHRI 700 standards following purification at said first and second purification stations, the target refrigerant system including a blending station configured to provide reclaimed refrigerant blends components consistent with AHRI 700 standards;
h. an oligomer inhibitor tank system and a tracer tank system respectively containing a supply of (1) at least one oligomer inhibitor, and (2) at least one tracer selected from the group consisting of HFO-Z/E-1336mzz, HFO-1233zd, HFO-1224 yd, HFO-1112, HFO-1327, HFO-1336yf, HFO-1336ze, and HFC-263fb, the oligomer inhibitor tank system and the tracer tank system being configured to add effective quantities of the at least one oligomer inhibitor and/or the at least one tracer to the targeted reclaimed refrigerants and reclaimed refrigerant blends; and
i. a purity check station configured to check the purity of the unreclaimed refrigerant before purification, and/or after the first and/or second purification treatments, and to determine whether or not the first treated product meets or exceeds AHRI 700 standards.

36-38. (canceled)

39. The system as in claim 35, wherein at least one of the first and second purification systems includes one of a distillation column, an adsorption/desorption column, and a cryogenic cooler.

40. The system as in claim 35, wherein at least one of the first and second purification systems includes one of a NCG purge unit, a water distillation or desiccant dryer unit, a solids filter unit, an acidity neutralizer, and a high distillation residue column.

41. A process comprising feeding an unreclaimed refrigerant composition comprising at least one of HFO-1234yf, HFO-Z/E-1234ze, HFO-E-1225ye, HFO-Z/E-1336mzz and HFO-Z/E-1132, optionally including at least one additional component selected from HFC-152a, HFC-134a, HFC-32, HFC-125, HFC-143a, HFC-227ea, and CH₃I, to the system according to claim 35, and recovering a stabilized and traceable reclaimed refrigerant composition.

42. The process as in claim 41, wherein the unreclaimed refrigerant composition comprises:
HFC-32; or
HFC-32 and HFC-125, or
HFC-134 and HFC-125, HFC-32, or
HFC-134a and HFC-125; or
HFO1234yf; or
HFO-Z/E-1234ze; or
HFO-E/Z-1336mzz; or
HFO-1234yf and HFO1234ze; or
HFO-1234ze and HFO-E/Z-1336mzz; or
HFO-1234yf and at least one of HFC-32, HFC-134a, HFC-125; HFC-152a and CO₂ (R744); or
HFO-Z/E-1234ze and at least one of HFC-32, HFC-134a, HFC-125 and HFC-227ea; or
HFO-1234yf, HFO-Z/E-1234ze and at least one of HFC-32, HFC-134a, or HFC-125.

43. The process as in claim 41, wherein the weighing and testing station is configured to detect the acidity, air, oil, particulates/solids, stabilizer, and moisture content of the unreclaimed refrigerant composition.

44. The process as in claim 41, wherein the inhibitor is selected from the group consisting of propane, cyclopropane, propylene, butane, butane, isobutene and mixtures of two or more, d-limonene, I-limonene, β-pinene, α-pinene, α-terpinene, β-terpinene, γ-terpinene, and δ-terpinene, d-limonene/propane, I-limonene/propane, β-pinene/propane, α-pinene/propane, α-terpinene/propane, β-terpinene/propane, γ-terpinene/propane, and δ-terpinene/propane, d-limonene/cyclopropane, I-limonene/cyclopropane, β-pinene/cyclopropane, α-pinene/cyclopropane, α-terpinene/cyclopropane, β-terpinene/cyclopropane, γ-terpinene/cyclopropane, and δ-terpinene//cyclopropane, d-limonene/butane, I-limonene/butane, β-pinene/butane, α-pinene/propane, α-terpinene/butane, β-terpinene/butane, γ-terpinene/butane, and δ-terpinene/butane, d-limonene/isobutane, I-limonene/isobutane, β-pinene/isobutane, α-pinene/isobutane, α-terpinene/isobutane, β-terpinene/isobutane, γ-terpinene/isobutane, and δ-terpinene//isobutane, d-limonene/butene, I-limonene/butene, β-pinene/butene, α-pinene/butene, α-terpinene/butene, β-terpinene/butene, γ-terpinene/butene, and δ-terpinene/butene.

45. A process comprising:
a) providing an unreclaimed refrigerant composition including at least one component selected from the group consisting of HFC-32, HFC-134, HFC-134a, HFC-125, HFC-143a, HFC-152a, HFC-227ea, HFO-1234yf, HFO-Z/E-1234ze, HFO-E-1225ye, HFO-E/Z-1336mzz, and HFO-Z/E-1132;
b) (1) weighing and testing the unreclaimed refrigerant composition of step a) to determine at least one parameter selected from the group consisting of the refrigerant components, presence and/or content of contaminants, presence and/or content of non-condensable gases (NCG), and physical properties, and (2) checking and comparing the purity of the unreclaimed refrigerant composition relative to AHRI 700 standards;
c) if unreclaimed refrigerant composition of step a) does not meet the AHRI 700 standards, selecting physical and/or chemical treatments in accordance with step b) (1) and treating and purifying the unreclaimed refrigerant composition of step b) (1) and providing a first treated product;
d) checking the purity of the first treated product of step c) and determining whether or not the first treated product meets or exceeds AHRI 700 standards;
e) optionally (1) adding at least one additional refrigerant component to the first treated product to form a first target refrigerant or refrigerant blend if the first treated product meets or exceeds AHRI 700 standards, or (2) further purifying the first treated product if it does not meet AHRI 700 standards to produce a second treated product and checking the purity of the second treated product to determine if it meets or exceeds AHRI 700 standards;
f) optionally adding at least one additional refrigerant component to the second treated product if it meets or exceeds AHRI 700 standards to form a second target refrigerant or refrigerant blend;
g) optionally adding an effective amount of at least one oligomer inhibitor selected from the group consisting of ethane, propane, cyclopropane, limonene or pinene, propane and limonene, propane and pinene, cyclopropane and limonene, and cyclopropane and pinene; and/or
h) optionally adding at least one tracer selected from the group consisting of HFO-Z/E-1336mzz, HFO-1233zd, HFO-1224 yd, HFO-1112, HFO-1327, HFO-1336yf, HFO-1336ze, and HFC-263fb to the first and/or second target refrigerant or refrigerant blends of step e) and or f), with the proviso that the at least one tracer is different from the at least one component.

46. The process of claim 1, wherein the unreclaimed refrigerant is HFO-1234yf or an HFO-1234yf blend and the treating of step c) comprises passing the unreclaimed HFO-1234yf or HFO-1234yf blend, in a liquid state, through an absorbent material to reduce or remove an oligomerization inhibitor and then subjecting the inhibitor-reduced or inhibitor-free refrigerant to distillation.

47. The system of claim 35, wherein the purification system includes a bed of absorbent to reduce or remove oligomerization inhibitor from the unreclaimed refrigerant, and the system is configured to transfer the inhibitor-reduced or inhibitor-free refrigerant from the bed of absorbent to and through one or more distillation columns.

48. (canceled)

49. The process of claim 46, wherein at least one of the unreclaimed refrigerant and reclaimed refrigerant is located in a weighable container comprising an air/oxygen detector.

50. The system of claim 35, further comprising at least one of an unreclaimed refrigerant receiving vessel or reclaimed refrigerant container comprising an air/oxygen detector.

51. The process of claim 46, wherein the unreclaimed, partially reclaimed or completely reclaimed refrigerant is filtered to remove solids prior to any distillation, optionally said solids comprises fluoroolefin derived by-products.

52. The system of claim 47, further comprising filters for the unreclaimed, partially reclaimed or completely reclaimed refrigerants to remove solids prior to or after any distillation, optionally said solids filter comprising filters for fluoroolefin derived by-products.

53. (canceled)

54. The process as in claim 1, wherein the unreclaimed fluoroolefin refrigerant composition comprises HFO-1336mzz(Z), HFO-1336mzz(E) or a mixture of HFO-1336mzz(Z) and HFO-1336mzz(E).
